(19) United States
(12) Patent Application Publication
(10) Pub. No.: US 2002/0191254 A1
(43) Pub. Date: Dec. 19, 2002

(54) Network routing employing free-space optical broadcasting

(76) Inventor: Robert Mays JR., Austin, TX (US)

Correspondence Address: Kenneth C. Brooks, P.O. Box 10417, Austin, TX, 78766-1417, US

(21) Appl. No.: 09/884,562

(22) Filed: Jun. 19, 2001

(51) Int. Cl. H04B 10/20; H04J 14/00; H04B 10/00

(52) U.S. Cl. 359/152; 359/118

(57) ABSTRACT

A method and a network to transfer data between computing environments employing holographic transform functions. Each of the computing environments communicate via an optical transceiver system that includes a plurality of optical sources, an optical detector, a dispersive element in optical communication with the plurality of optical sources and a plurality of holographic transform functions. Each of the detectors is uniquely associated with one of the plurality of computing environments. The holographic transform function associated with one of the detectors of the plurality of computing environments differs from the holographic transform functions associated with the detectors of the remaining computing environments of the plurality of computing environments.

### BACKGROUND OF THE INVENTION

The present invention relates to a wireless, or free space, communication. Particularly, the present invention concerns free-space optical routing techniques for various computer networks.

Computer networks are often classified in accordance with the geographic area encompassed by the same and have traditionally classified as either local area networks (LANs) or wide area networks (WANs). LANs are generally limited to computers within a relatively small area, such as a building, office or campus. WANs, on the other hand, connect computers over larger geographic scopes, such as from one city to another. In the past few years, less commonly known classifications have evolved. These classifications include metropolitan area networks (MANs) and global area networks (GANs). MANs typically encompass several cities within a large metropolitan zone, e.g., the San Francisco Bay Area, the New York Metropolitan area and the Dallas Metropolitan area to name a few. The most prominent example of a GAN is the Internet.

Various technologies have evolved to facilitate communications and/or data transmission in computer networks. These include the Ethernet, the token ring, the fiber distributed data interface (FDDI), and the asynchronous transfer mode (ATM). Data transmission within and between networks using such technologies are governed by various protocols, such as frame relay (FR), X.25, integrated services digital network (ISDN), media access control address protocol, and transmission convergence protocol/internet protocol (TCP/IP).

As with other forms of digital communications, data in computer networks is commonly transmitted in packets or frames, i.e.—discrete bundles of data. Frames are comprised of various fields, such as header, address, data, and control fields. The arrangement or format of these fields within a frame is protocol-dependent. However, other frame formats are also in use.

A given communication or data transmission process in a network often requires the delivery of multiple packets or frames of data from a source to a destination within the network. For example, retrieval of a file using file transfer protocol (FTP) will generally be accomplished using a large number of frames. Although relating to the same process (i.e., FTP), different frames may be transmitted via different paths within the network. As used herein, data flow refers to a sequence of related frames sent from a particular source to a particular destination within the network.

Various devices exist for transmitting packets or frames of data within a network or between networks. One such device is referred to as a bridge or gateway. Bridges pass frames of data from one network to another, the two networks typically being local area networks. Bridges store and forward frames of data, looking at the low-level addressing and not at the frame's internal data to determine where the frames are sent.

Another device for transmitting data between computing environments in, or between, networks are routers. Routers usually route frames of data at a higher level protocol than is handled by bridges. One example of a router employs the Internet protocol (IP) and is referred to as an IP router. However, other protocols are also employed in routers, such as InterPacketExchange (IPX) by Novell, Inc. and high performance routing (HPR) by International Business Machines Corporation of Armonk, N.Y. Like bridges, routers store and forward frames. However, a router, after storing a frame of data, looks into the internal data of the frame for higher protocol information regarding the ultimate destination of the frame. A router then consults an internal table of available paths to the ultimate destination and corresponding protocols supported by those paths, and makes a decision regarding how to route the frame to its ultimate destination.

If a router encounters a frame of data not fitting into the list of protocols that it routes, it bridges the frame. Routers, therefore, first attempt to route the data, then, if necessary, bridge the data. As a result, routers are typically connected to two or more LANs or WANs. Routers may also be required to interface between multiple protocols.

Yet another device for transmitting data between computing environments in, or between, networks are switches. Switches are hardware devices that provide physical connections within or between different networks. Unlike bridges and routers, a switch typically forwards data without first storing the entire frame. The delays inherent in storing the entire frames before forwarding are thus eliminated. A switch transmits the data bits of the frame received from the source port directly to the destination port as soon as the destination is ascertained. Early switches were included in telephone networks and other WANs. In WAN environments, for example, Frame Relay and ATM protocols are capable of using switches. Routers typically include Frame Relay Access Devices (FRAD) to LANs and WANs.

Historically, each of the aforementioned devices of various computing environments have been connected over telephone lines that consist of twisted pair of copper wires. Recent trends have placed various computing environments in data communication employing fiber optic cable. While both of these coupling techniques provide acceptable data transfer rates, the capital expenditure required to establish a new networking infrastructure or augment an existing infrastructure has proven to be prohibitive. This is particularly true in metropolitan areas where the cost of installing new cables, either copper or fiber, includes not only the material cost of the cables, but also the civil engineering costs associated with installing the same.

What is needed, therefore, is a networking technique that may be implemented without incurring the costs associated with traditional cable networking techniques.

### SUMMARY OF THE INVENTION

A method and a network to transfer data between computing environments employing holographic transform functions. Each of the computing environments communicates via an optical transceiver system that includes a plurality of optical sources, an optical detector, a dispersive element in optical communication with a plurality of optical sources, and a plurality of holographic transform functions. Each of the detectors is uniquely associated with one of the plurality of computing environments. The holographic transform function associated with one of the detectors of the plurality of computing environments subsystems differs from the holographic transform functions associated with the detectors of the remaining computing environments. In this manner, each pair of plurality of computing environments is associated with a pair of holographic transform functions that differs from the pair of holographic transform functions associated with the remaining pairs of computing environments. This facilitates concurrent communication between the computer environments of the network over a common volume, e.g., free-space, while avoiding cross-talk.

### BRIEF DESCRIPTION OF THE DRAWINGS

FIG. 1 is a simplified plan view of a metropolitan area network (MAN), in accordance with the present invention;

FIG. 2 is detailed view of an optical transceiver system employed in the MAN shown in FIG. 1, in accordance with the present invention;

FIG. 3 is a simplified plan view of a dispersive element employed in the optical transceiver system shown in FIG. 2;

FIG. 4 is a simplified plan view of an alternate embodiment of the dispersive element shown in FIG. 3, in accordance with the present invention;

FIG. 5 is a simplified plan view of a second alternate embodiment of the dispersive element shown in FIG. 3, in accordance with the present invention;

FIG. 6 is a simplified plan view showing an apparatus for fabricating the focusing transform elements shown in FIG. 2, in accordance with the present invention;

FIG. 7 is a graphical representation showing charge distribution changes in the volume of a photosensitive sheet shown in FIG. 6, in relation to the optical energy impinging thereupon and the resulting strain in the material of the volume;

FIG. 8 is a cross-sectional view of a substrate on which the focusing transform elements discussed with respect to FIG. 2 are fabricated;

FIG. 9 is a cross-sectional view of the substrate shown above in FIG. 8, undergoing processing, and showing a photo-resist layer disposed thereon;

FIG. 10 is a cross-sectional view of the substrate shown above in FIG. 9, undergoing processing, showing a photo-resist layer being patterned;

FIG. 11 is a cross-sectional view of the substrate shown above in FIG. 10, undergoing processing after a first etch step;

FIG. 12 is a cross-sectional view of the substrate shown above in FIG. 11, undergoing processing after a second etch step; and

FIG. 13 is perspective view of an array of the focusing transform elements fabricated on a photo-sheet, shown in FIG. 6.

### DETAILED DESCRIPTION OF THE INVENTION

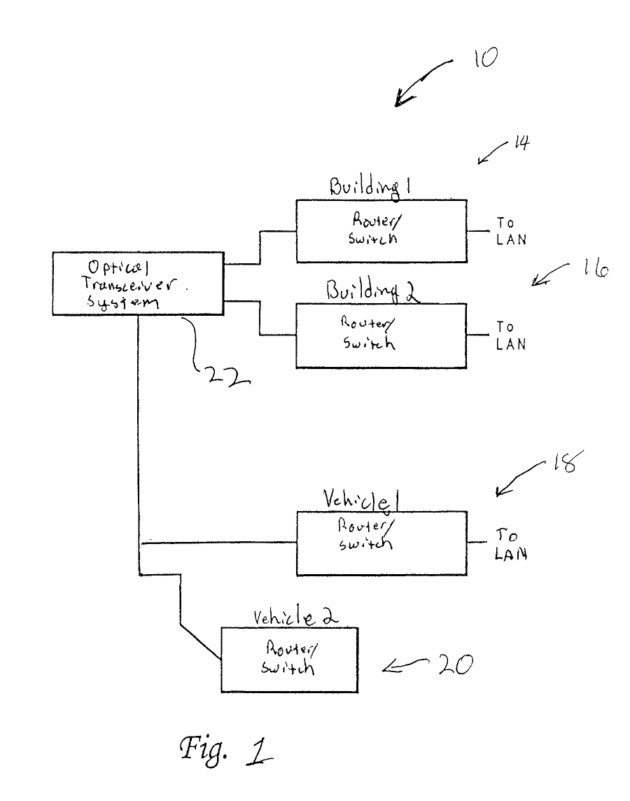

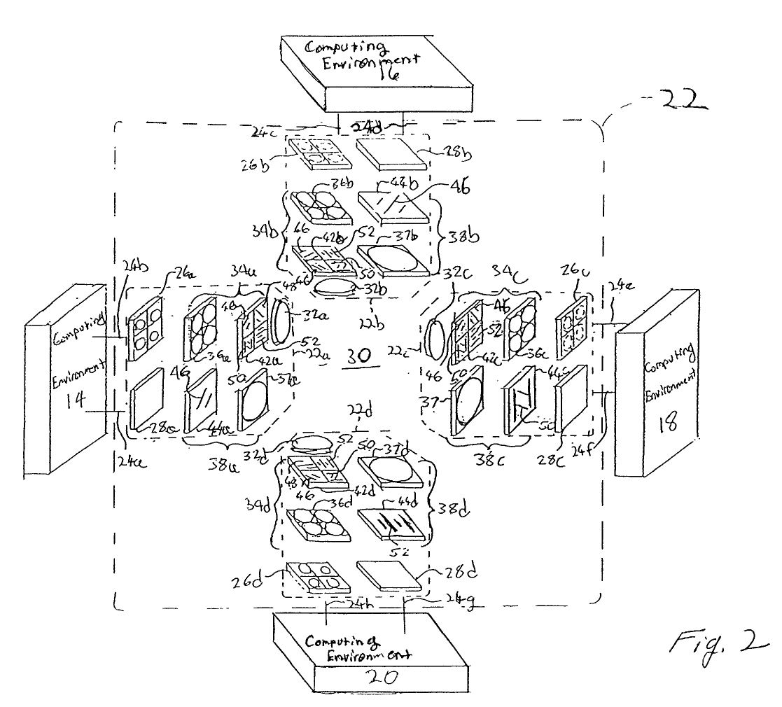

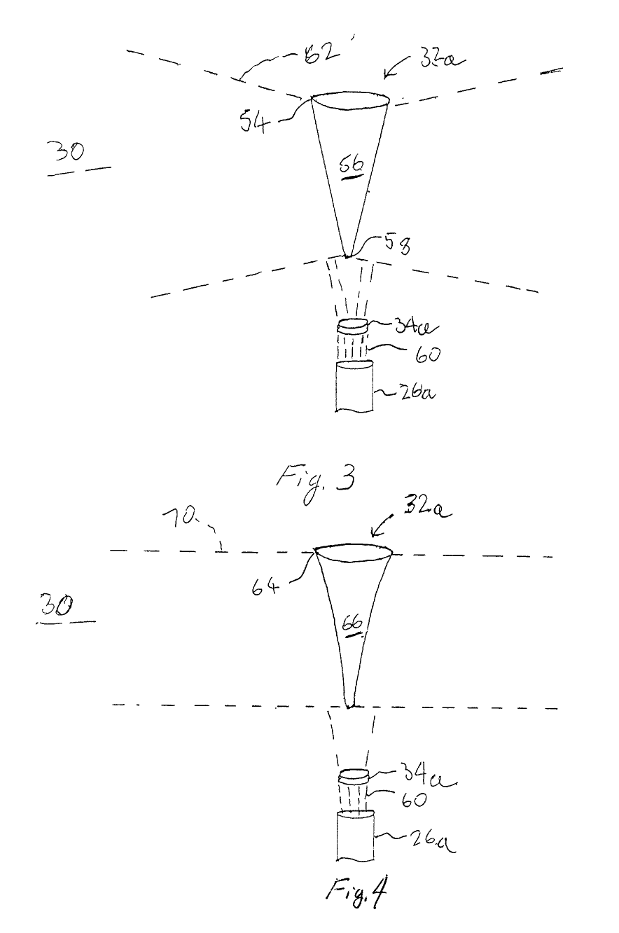

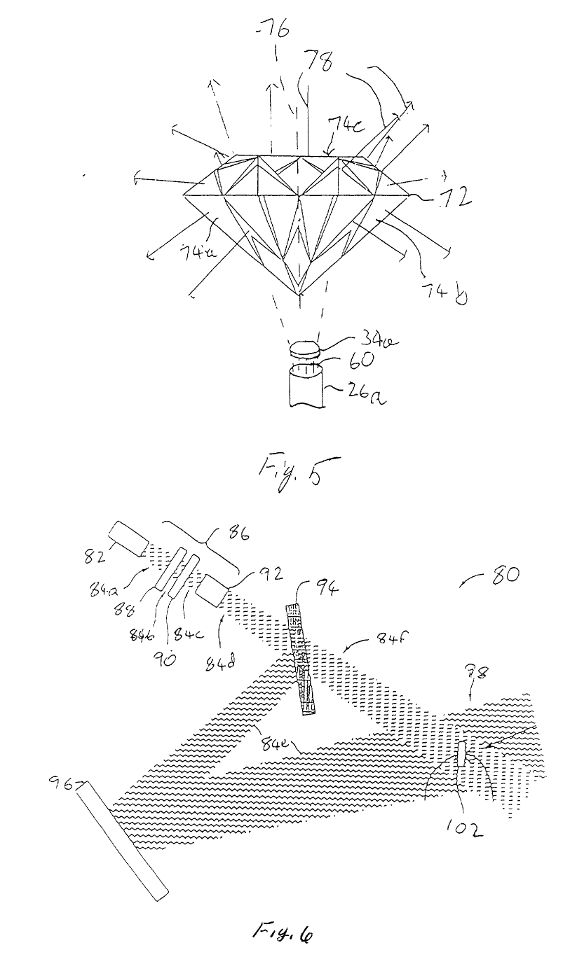

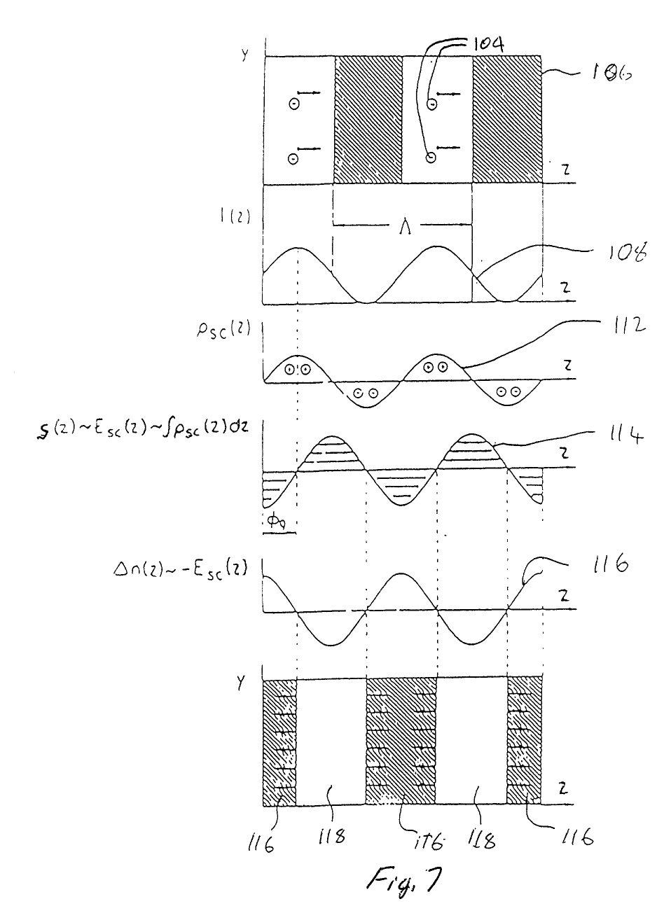

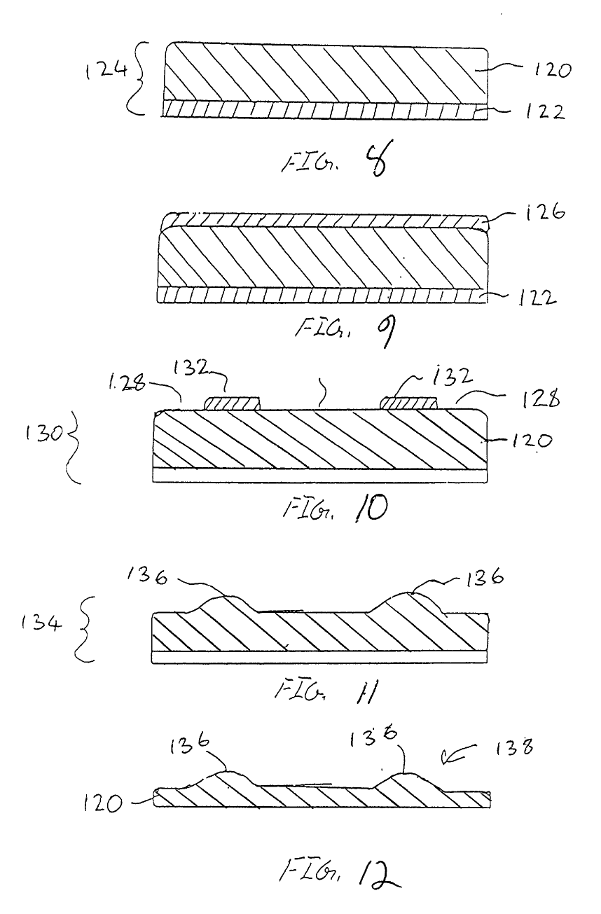

Referring to FIG. 1, shown is a network 10 over which a plurality of computing environments, shown generally as 14, 16, 18 and 20 communicate via an optical transceiver system 22. As shown, computing environments 14 and 16 are located in different buildings, i.e., Building 1 and Building 2, respectively. These buildings may be in a common city or in different cities, but are typically in the same metropolitan area. As a result, network 10 is commonly referred to as a Metropolitan Area Network (MAN). Building 1 and Building 2 often include one or more a local area networks (LANs) for the tenants in the buildings. To that end, each of Building 1 and Building 2 may be any permanent or semi-permanent structure, such as a commercial building, apartment building, stadium or the like.

Computing environments 18 and 20 are associated with vehicles, i.e., vehicles 1 and 2, respectively. The term vehicle implies that any mode of transportation may be included. For example, vehicle 1 is shown as including one or more LANs. As a result, vehicle 1 may be a bus with multiple users of PCs connected to one or more LANs on the bus. Alternatively, vehicle 1 may be a van, aircraft or passenger car in which multiple users are in data communication with optical transceiver system 22, i.e., in MAN service through optical transceiver system 22. Vehicle 2 may be any vehicle not having a LAN associated therewith, i.e., a single occupancy vehicle such as a commuter automobile or an individual on a motorcycle, bicycle or a pedestrian in data communication with optical transceiver system 22.

Referring to FIG. 2, shown is a detailed plan view of optical transceiver system 22 connected to each of computing environments 14, 16, 18 and 20. Specifically, optical transceiver system 22 includes a plurality of holographic multiplexing subsystems 22a, 22b 22c and 22d that are uniquely associated with each computing environment 14, 16, 18 and 20.

Specifically, computing environment 14 is in electrical communication with holographic multiplexing subsystem 22a over lines 24a and 24b. Computing environment 16 is in electrical communication with holographic multiplexing subsystem 22b over lines 24c and 24d.

Computing environment 18 is in electrical communication with holographic multiplexing subsystem 22c over lines 24e and 24f, and computing environment 20 is in electrical communication with holographic multiplexing subsystem 22d over lines 24g and 24h. Each of the holographic multiplexing subsystems 22a, 22b 22c and 22d includes a 2×2 array of optical transmitters, shown generally as 26a-d, respectively, as well as an optical detector, shown generally as 28a-28d, respectively. Each array 26a-26d generates optical energy to propagate through a volume 30, and optical detectors 28a-28d are positioned to sense optical energy propagating through volume 30. An exemplary volume 30 is the atmosphere of a metropolitan area in which the network is employed. In this manner, computing environments 14, 16, 18 and 20 communicate through volume 30 via free-space optical interconnections.

The optical energy from each of the individual transmitters of arrays 26a-26d is dispersed throughout volume 30 to ensure that the same is sensed by detectors 28a-28d. To that end, included in each of the holographic multiplexing subsystems 22a, 22b 22c and 22d is an optical dispersion device 32a, 32b, 32c and 32d, respectively. Optical dispersions devices 32a, 32b 32c and 32d are discussed more fully below with respect to FIG. 3. A focusing element 34a, 34b, 34c and 34d is included in each of holographic multiplexing subsystems 22a, 22b 22c and 22d, respectively. Focusing element 34a is disposed between array 26a and dispersion device 32a to ensure that optical energy produced by the transmitters of array 26a impinge upon optical dispersion device 32a. Focusing element 34b is disposed between array 26b and dispersion device 32b to ensure that optical energy produced by the transmitters of array 26b impinge upon optical dispersion device 32b. Focusing element 34c is disposed between array 26c and dispersion device 32c to ensure that optical energy produced by the transmitters of array 26c impinge upon optical dispersion device 32c. Focusing element 34d is disposed between array 26d and dispersion device 32d to ensure that optical energy produced by the transmitters of array 26d impinge upon optical dispersion device 32d. To that end, each of focusing elements 34a, 34b, 34c and 34d includes an array of refractive lens elements 36a-36d, respectively.

Lens elements of the array 36a are arranged to match the pitch and sizing of the transmitters of the array 26a, and each lens element has a numerical aperture of sufficient size to collect substantially all of the optical energy produced by the transmitters disposed adjacent thereto. Lens elements of the array 36b are arranged to match the pitch and sizing of the transmitters of the array 26b, and each lens element has a numerical aperture of sufficient size to collect substantially all of the optical energy produced by the transmitters disposed adjacent thereto. Lens elements of the array 36c are arranged to match the pitch and sizing of the transmitters of the array 26c, and each lens element has a numerical aperture of sufficient size to collect substantially all of the optical energy produced by the transmitters disposed adjacent thereto. Lens elements of the array 36d are arranged to match the pitch and sizing of the transmitters of the array 26d, and each lens element has a numerical aperture of sufficient size to collect substantially all of the optical energy produced by the transmitters disposed adjacent thereto.

An additional focusing element 38a-d is included in each holographic multiplexing subsystem 22a, 22b, 22c and 22d. As shown, focusing element 38a is disposed between volume 30 and detector 28a, and includes refractive lens element 40a. Focusing element 38b is disposed between volume and detector 28b and includes refractive lens element 40b. Focusing element 38c is disposed between volume 30 and detector 28c and includes refractive lens element 40c. Focusing element 38d is disposed between volume and detector 28d and includes refractive lens element 40d. Each refractive lens element 40a, 40b, 40c and 40d collects optical energy impinging thereupon and focuses the same onto a detector 28a, 28b, 28c and 28d, respectively.

To improve channel discrimination among detectors 28a-28d, included in each of focusing elements 34a-d and 38a-d are diffractive transform elements. Specifically, focusing element 34a includes diffractive transform element 42a, and focusing element 34b includes diffractive transform element 42b. Focusing element 34c includes diffractive transform element 42c, and focusing element 34d includes diffractive transform element 42d. Focusing element 38a includes diffractive transform element 44a, and focusing element 38b includes diffractive transform element 44b. Focusing element 38c includes diffractive transform element 44c, and focusing element 38d includes diffractive transform element 44d.

Each of diffractive transform elements 42a-42d includes four of holographic transform functions, shown generally as hashed lines 46, 48, 50, and 52. Each of diffractive transform elements 44a-44d includes only one of the aforementioned holographic transform functions 46, 48, 50, and 52. Specifically, diffractive transform element 44a includes holographic transform function 46, and diffractive transform element 44b includes holographic transform function 48. Diffractive transform element 44c includes holographic transform function 50, and diffractive transform element 44d includes holographic transform function 52.

Each of the holographic transform functions 46, 48, 50 and 52 filters optical energy propagating therethrough by removing unwanted characteristics therefrom. The unwanted characteristics that may be removed from the optical energy include amplitude wavelength and/or polarization information by transforming the wavefront of the beam propagating therethrough, in accordance with the holographic transform function. As a result, any information contained in the optical energy propagating through the holographic transform function may not be sensed without the transformed wavefront being operated on by the same holographic transform function. This is due to the inherent properties of holographic transform functions. This results in improved channel discrimination by transforming optical energy, in accordance with a holographic transform function, so as to have unique characteristics before entering volume 30. In this manner, information contained in the transformed optical energy may be sensed only by a sensor associated with a matching holographic transform function, i.e., a sensor capable of performing an inverse transform on the transformed optical energy.

To that end, each of the holographic transform functions 46, 48, 50 and 52 are different, and each detector 28a-d is associated with only one of the aforementioned holographic transform functions. With this configuration, each holographic multiplexing subsystem 14, 16, 18 and 20 may transform optical energy transmitted thereby with any one of the holographic transform functions 46, 48, 50 and 52, but may sense information so long as the same has been transformed with the holographic transforms function associated therewith. In this manner, each holographic multiplexing subsystem 22a, 22b, 22c and 22d and, therefore, computing environments 14, 16, 18 and 20, communicate information through a pair of holographic transform functions that differ from the pair of holographic transform functions through which the remaining pairs of holographic multiplexing subsystems 22a, 22b, 22c and 22d communicate.

For example, were computing environment 14 to send data to computing environment 16, then one of the transmitters of array 26a would generate optical energy modulated with the data, producing modulated optical energy. The modulated optical energy would impinge upon refractive lens element 36a that would focus the same energy onto holographic transform function 48 of diffractive transform element 36a. This would transform the modulated optical energy, producing transformed optical energy. The transformed optical energy would be broadcast through volume 30. Although each of detectors 28a-28d could sense the transformed optical energy, but only the detector associated with a matching holographic transform function would sense the data. As a result, detector 28b would sense that data, because the refractive lens element 40b would collect the transformed modulated optical energy. The optical energy collected by refractive lens element 40b would focus the same onto diffractive transform element 44b having a holographic transform function 48 recorded therein. Diffractive lens element 44b would perform an inverse transform function on the optical energy propagating therethrough, because the holographic transform function 48 of diffractive transform element 44b matches holographic transform function 48 of diffractive transform element 42a through which the optical energy propagated. This would allow detector 28b to sense the data on the optical energy.

Were data transmitted to computing environment 14 from computing environment 16, then holographic multiplexing subsystem would cause the transmitter of array 26b to propagate energy through holographic transform function 46 of array 42b. Holographic transform function 46 is the holographic transform function that is associated with detector 28a of holographic multiplexing subsystem 22a.

It should be noted that proper channel discrimination requires that each holographic multiplexing subsystem have the capability of transmitting optical energy that is transformed by a single holographic transformation 46, 48, 50 or 52. To that end, in one embodiment of the present invention, the refractive lens elements are formed integrally with the diffractive transform elements of each focusing element. The focusing elements are attached to the transmitter array so that each holographic function is adjacent to and uniquely associated with a transmitter. As a result, by individually activating the transmitters of an array, the holographic transform function employed to transform optical energy entering volume 30 may be selected. It is, of course, feasible to broadcast across all channels by activating all transmitters of one or more transmitter arrays, as desired. To that end, each of the transmitters of the array may consist of one or more semiconductor lasers or one or more ends of optical fibers in optical communication with one or more semiconductor lasers. Detectors may comprise of virtually any optical detector known, such as charged coupled devices (CCD) or charge injection detectors (CID).

Channel discrimination may be further augmented by employing transmitters 26a-d having different wavelengths or by incorporating up-conversion processes that include optical coatings applied to the individual transmitters 26a-26d or made integral therewith. One such up-conversion process is described by F. E. Auzel in “Materials and Devices Using Double-Pumped Phosphors With Energy Transfer”, Proc. of IEEE, vol. 61. no. Jun. 6, 1973.

Referring to FIGS. 2 and 3 shown is an exemplary dispersive element 32a employed in holographic multiplexing subsystem 22a that includes a body 54. Body 54 includes an exterior surface 56 having a conical shape. Transmitter array 26a is positioned proximate to a vertex 58 of body 54. Surface 56 extends from vertex 58, away from the transmitter array. Disposed between the transmitter array 26a and body 54 is focusing element 34a. Surface 56 is arranged to reflect optical energy 60 produced by transmitter array 26a. Transmitter array 26a is positioned so to maximize the area of surface 56 upon which optical energy impinges. As a result optical energy reflecting from surface 56, shown as 62, diverges. In this manner, information, or data, modulated onto optical energy 62 is broadcast throughout volume 30.

Referring to FIGS. 2 and 4 another embodiment of dispersive element 32a includes body 64 that has a hyperbolic exterior surface 66 that reflects optical energy 68 produced by transmitter array 26a. The shape of surface 66 may be selected to create a parallel sheet of optical energy 70 that is broadcast throughout volume 30.

Referring to FIGS. 2 and 5 another embodiment of dispersive element 32a includes body 72 that has a faceted exterior surface that includes a plurality of planar regions, three of which are shown as 74a, 74b and 74c. Planar regions 74a, 74b and 74c lie in planes that are orientated at differing angles with respect to a longitudinal axis 76 of body 72. An exemplary body 72 may be a solitaire diamond. With this configuration optical energy is broadcast in various directions throughout volume, shown by arrows 78.

Referring to FIGS. 2-5, although the foregoing bodies 54, 64 and 72 have been described with respect to dispersive element 32a, these bodies 54, 64 and 72 may be used in connection with dispersive elements 32b-32d. It should be understood that dispersive elements 32a-32d should be in optical communication with volume 30. As a result, dispersive elements 32a and 32b may be mounted on the roof or exterior wall of the building in which computing environment 14 is located. Dispersive elements 32c and 32d may be mounted to the roof of the vehicle, or on the helmet of a pedestrian, using computing environment 18 and 20, respectively.

Referring to both FIGS. 2 and 6, each of the transform functions 46, 48, 50 and 52 are recorded individually as a periodic arrangement of space-charge field of material from which diffractive transform elements 42a-42d are fabricated. For example, transform function 46, is recorded employing a system 80 that includes a beam source 82 that directs a beam 84a into wave manipulation optics 86, such as a ¼ waveplate 88, so that a beam 84b is circularly polarized. Beam 84b impinges upon polarizer 90 so that a beam 84c propagating therethrough is linearly polarized. Beam 84c impinges upon a Faraday rotator 92 that changes birefringence properties to selectively filter unwanted polarizations from beam 84c. In this manner, a beam 84d egressing from the rotator 92 is linearly polarized. Beam 84d impinges upon a beam splitter 94 that directs a first subportion 84e of beam 84d onto a planar mirror 96. A second subportion 84f of beam 84d passes through splitter 94. The first and second subportions 84e and 84f intersect at region 98 forming an optical interference pattern that is unique in both time and space. The material from which filtering apparatus 100 is formed, photosensitive sheet 102, is disposed in the region so as to be exposed to the optical interference pattern. The interference pattern permeates the photosensitive sheet 102 and modulates the refractive index and charge distribution throughout the volume thereof. To that end, sheet 102 may be formed from any suitable photo-responsive material, such as silver halide or other photopolymers. Other materials from which sheet 102 may be formed include LiNbO₃, LiTaO₃, BaTiO₃, KnbO₃, Bi₁₂SiO₂₀, Bi₁₂GeO₂₀, PbZrO₃, PbTiO₃, LaZrO₃, or LaTiO₃.

Referring to FIGS. 2, 6 and 7, the modulation that is induced throughout the volume of the photosensitive sheet 102 is in accordance with the modulation properties of the first and second subportions 84e and 84f. A subportion of the aforementioned volume is shown as 104. A cross-section of volume 104 is shown as 106. An interference pattern, shown for simplicity as 108, is produced by beams 84e and 84f. Interference pattern 108 induces changes in refractive indices of volume 106 based on the spatial modulation of photocurrents that results from non-uniform illumination. Charges such as electrons 110, or holes, migrate within volume 106 due to diffusion and/or drift in an electric field present therein, referred to as photo-excited charges. The generation of photocurrents at low beam intensity depends on the presence of suitable donors. The photo-excited charges, which are excited from the impurity centers by interference pattern 108, are re-trapped at other locations within volume 106. This produces positive and negative charges of ionized trap centers that are re-excited and re-trapped until finally drifting out of the region of volume 106 upon which the interference pattern 108 impinges. This produces a charge distribution within volume 106, shown by curve 112. Charge distribution 112 creates a strain through volume 106, shown by curve 114 that produces regions of negative charge concentration 116 and regions of positive charge concentration 118. The resulting space-charge field between the ionized donor centers and the trapped photo-excited charges modulates the refractive indices, which is shown graphically by curve 116. As a result, the holographic transform function includes information associated with the interference pattern generated by the superposition of the first and second sub-portions 84e and 84f, such as the amplitude, phase and wavelength components of the same. This information is recorded throughout the entire bulk or volumetric thickness, v_{δ}, of sheet 102.

The volumetric thickness, v_{δ}, is defined to be the thickness required to record a complete holographic transform function. It has been determined that, for a given material, the volumetric thickness, v_{δ}, is inversely proportion to the wavelengths of first and second sub-portions 84e and 84f that create the interference pattern. A volumetric thickness, v_{δ}, as little as several microns was found suitable for recordation of a single holographic transform in the near-infrared optical frequencies. With the appropriate volumetric thickness, v_{δ}, all of the physical properties associated with the photonic or electromagnetic waves of the interference pattern, e.g., spatial and temporal (phase) aspects, wavelength, amplitude, polarization, etc. are stored in volume of sheet 102. Holographic transform functions act as a gateway to provide real-time and near real-time optical filtering.

From the foregoing it is seen that each of the holographic transform functions defined on the sheet 102 would be substantially identical. Thus, to create differing holographic transform functions, e.g., 46, 48, 50 and 52, additional photosensitive sheets 102 are employed. Considering that the interference pattern is unique in both time and space, a subsequent sheet 102 disposed in region 98 would have a differing transform function recorded therein thereon than the transform function recorded on a sheet 102 at an earlier time. This is due, in part, to the time-varying fluctuations in the operational characteristics of the various components of system 80. As a result multiple sheets 102 are formed, each of which has a transform function associated therewith that differs from the transform function associated with the remaining sheets. After forming the aforementioned multiple sheets, the holographic transform functions on each of the sheets is segmented so that the same may be arranged appropriately to be positioned proximate to one or more transmitters and one or more detectors, as desired.

Alternatively, or in addition, the Faraday rotator 92 may be rotated to provide the lenses formed on the photosensitive sheet 102 with a holographic transform function that differs from the transform function associated with the lenses formed on a previous photosensitive sheet 102.

To fabricate each focusing elements 34a-d and 38a-d to have the refractive lens and diffractive holographic transform functions, the manufacturing process of photosensitive sheet 102 includes providing a photosensitive layer 120 adhered to a sacrificial support 122, shown in FIG. 8. Examples of sacrificial layers include glass and plastic. Photosensitive layer 120 and sacrificial support 122 form a photosensitive substrate 124. Typically, photosensitive layer 120 is tens of microns thick. As shown in FIG. 9, a photo resist layer 126 is deposited onto the photosensitive layer 120 and is then patterned to leave predetermined areas exposed, shown as 128 in FIG. 10, defining a patterned substrate 130. Located between exposed areas 128 are photo resist islands 132. Patterned substrate 130 is exposed to a light source, such as ultraviolet light. This ultraviolet light darkens the volume of photo resist layer 126 that is coextensive with exposed areas 128 being darkened, i.e., become opaque to optical energy. The volume of photosensitive layer 120 that is coextensive with photo-resist islands 132 is not darkened by the ultraviolet light, i.e., remaining transparent to optical energy. Thereafter, photo resist islands 132 are removed using standard etch techniques, leaving etched substrate 134, shown in FIG. 11.

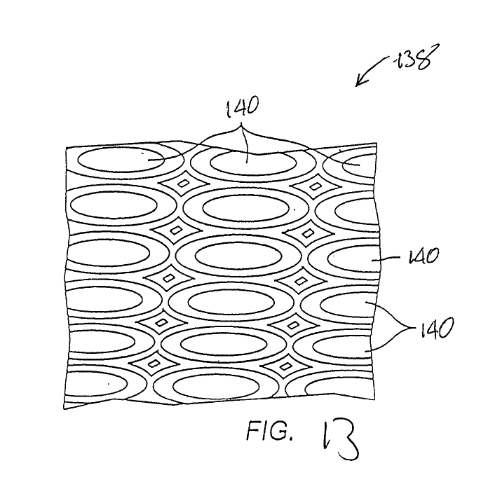

Etched substrate 134 has two arcuate regions 136 that are located in areas of the photosensitive layer 120 disposed adjacent to islands 132, shown in FIG. 12. Arcuate regions 136 of FIG. 11 result from the difference in exposure time to the etch process of the differing regions of photosensitive layer 120.

Referring to FIGS. 6, 11 and 13, a subsequent etch process is performed to form an array 138 of focusing elements 140. During this etch process the support is removed as well as nearly 50% of photosensitive layer 120 to form array 138 to be very thin. Array 138 is then placed in the system 80 and the bulk holographic transform functions are recorded in the arcuate regions 138 that define a subportion of focusing elements 34a-d and 38a-d discussed above with reference to FIG. 2. Thereafter, the focusing elements 140 may be segmented from array 138 to be included in 34a-d and 38a-d.

Although the invention has been described in terms of specific embodiments, one skilled in the art will recognize that various changes to the invention may be performed, and are meant to be included herein. Therefore, the scope of the invention should not be based upon the foregoing description. Rather, the scope of the invention should be determined based upon the claims recited herein, including the full scope of equivalents thereof.

What is claimed is:

1. A method of transferring data between a plurality of computing environments, each of which includes a plurality of optical sources and an optical detector, said method comprising:
associating a pair of plurality of computing environments with a pair of holographic transform functions, with said pair of holographic transform functions associated with said pair of computing environments differing from the pairs of holographic transform functions associated with the remaining pairs of computing environments of said plurality of computing environments;
producing, with one of said plurality of optical sources of said pair of computing environments, optical energy modulated with data, defining modulated optical energy;
transforming said modulated optical energy with one of said pair of holographic transform functions, defining transformed modulated optical energy;
broadcasting said transformed modulated optical energy into a volume by reflecting said transformed modulated optical energy from a body having a conically shaped body; and
sensing said data with the detector associated with the remaining computing environment of said pair of computing environments.

2. The method as recited in claim 1 wherein sensing said data energy further includes performing an inverse transform on said transformed modulated optical energy, with one of said pair of holographic transform functions associated with said pair of computing environments, before sensing said modulated optical, to retrieve said modulated optical energy.

3. The method as recited in claim 1 wherein broadcasting said transformed modulated optical energy into a volume further includes dispersing said transformed modulated optical energy into said volume by reflecting said transformed modulated optical energy from a reflective surface having a conical shape.

4. The method as recited in claim 1 wherein broadcasting said transformed modulated optical energy into a volume further includes propagating a toroidal sheet of transformed modulated optical energy into said volume by reflecting said transformed modulated optical energy from a surface having a hyperbolic shape.

5. The method as recited in claim 1 wherein broadcasting said transformed modulated optical energy into a volume further includes radiating said transformed modulated optical energy into said volume over a plurality of directions by reflecting said transformed modulated optical energy from a surface having a plurality of planar regions formed thereon.

6. The method as recited in claim 1 wherein one of said pair of computing environments is located in a first building and the remaining computing environments is located in a second building, spaced-apart from said first building.

7. The method as recited in claim 1 wherein one of said pair of computing environments is located in a building and the remaining computing environments is located in a vehicle.

8. The method as recited in claim 1 wherein one of said pair of computing environments is located in a first vehicle and the remaining computing environments is located in a second vehicle, spaced-apart from said first building.

9. A network, comprising:
a plurality of computing environments, each of which includes a plurality of optical sources and an optical detector and a dispersive element in optical communication with said plurality of optical sources; and
an optical transceiver system in data communication with each of said plurality of computing environments, said optical transceiver system including a plurality of holographic transform functions, each of which is associated with said detector of each of said plurality of computing environments, with said holographic transform function associated with one of the detectors said plurality of computing systems subsystems differing from the holographic transform functions associated with the detectors of the remaining computing environments of said plurality of computing environments.

10. The network as recited in claim 9 wherein said dispersive element further includes a body having a reflective exterior surface with a conical shape.

11. The network as recited in claim 9 wherein said dispersive element further includes a body having a reflective exterior surface with a hyperbolic shape.

12. The network as recited in claim 9 wherein said dispersive element further includes a body having a reflective exterior surface with a plurality of planar regions formed thereon.

13. The network as recited in claim 9 wherein one of said pair of computing environments is located in a first building and the remaining computing environments is located in a second building, spaced-apart from said first building.

14. The network as recited in claim 9 wherein one of said pair of computing environments is located in a building and the remaining computing environments is located in a vehicle.

15. The network as recited in claim 9 wherein one of said pair of computing environments is located in a first vehicle and the remaining computing environments is located in a second vehicle, spaced-apart from said first building.

16. A network, comprising:
a plurality of computing environments, each of which includes a plurality of optical sources and an optical detector and a dispersive element in optical communication with said plurality of optical sources;
means for associating a pair of plurality of computing environments with a pair of holographic transform functions, with said pair of holographic transform functions associated with said pair of computing environments differing from the pairs of holographic transform functions associated with the remaining pairs of computing environments of said plurality of computing environments;
means for producing, with one of said plurality of optical sources of said pair of computing environments, optical energy modulated with data, defining modulated optical energy;
means for transforming said modulated optical energy with one of said pair of holographic transform functions, defining transformed modulated optical energy;
means for broadcasting said transformed modulated optical energy into a volume by reflecting said transformed modulated optical energy from a body having a conically shaped body; and
means for sensing said data with the detector associated with the remaining computing environment of said pair of computing environments.

17. The network as recited in claim 16 wherein said means for sensing further includes means for performing an inverse transform on said transformed modulated optical energy, with one of said pair of holographic transform functions associated with said pair of computing environments.

18. The network as recited in claim 16 wherein said means for broadcasting further includes means for reflecting transformed modulated optical energy from a reflective surface to disperse said transformed modulated optical energy into said volume.

19. The network as recited in claim 16 wherein said means for broadcasting further includes means for reflecting transformed modulated optical energy from a reflective surface to propagate a toroidal sheet of transformed modulated optical energy into said volume.

20. The network as recited in claim 16 wherein said means for broadcasting further includes means for reflecting transformed modulated optical energy from a reflective surface to radiate said transformed modulated optical energy into said volume over a plurality of directions.
